(19) United States
(12) Patent Application Publication
(10) Pub. No.: US 2015/0183425 A1
(43) Pub. Date: Jul. 2, 2015

(54) INJECTOR-CORRECTING APPARATUS OF A HYBRID ELECTRIC VEHICLE AND A METHOD THEREOF

(71) Applicant: Hyundai Motor Company, Seoul (KR)

(72) Inventors: Kumlim CHOI, Seoul (KR); Yoonsung Koo, Seoul (KR)

(73) Assignee: Hyundai Motor Company, Seoul (KR)

(21) Appl. No.: 14/540,842

(22) Filed: Nov. 13, 2014

(30) Foreign Application Priority Data
Dec. 31, 2013 (KR) 10-2013-0168494

(51) Int. Cl. B60W 20/00; F02D 29/02; B60W 10/08; B60W 30/18; B60W 10/02; B60W 10/06; F02D 41/30; F02D 41/14

(52) U.S. Cl. CPC B60W 20/50; F02D 41/3017; F02D 29/02; F02D 41/1401; B60W 30/18072; B60W 10/02; B60W 10/06; B60W 10/08; F02D 2700/07; B60W 2030/18081; B60W 2030/1809; Y10S 903/93

(57) ABSTRACT

An injector correcting apparatus of a hybrid electric vehicle may include an engine generating power by combustion of a fuel, a motor supporting power of the engine and selectively operating as a generator, a clutch provided between the engine and the motor, an injector injecting the fuel to a combustion chamber of the engine, a driving information detector detecting driving information of a vehicle including driving distance of the vehicle, vehicle speed, coolant temperature, fuel temperature, and state of charge (SOC) of a battery, and a controller correcting fuel injection by increasing a fuel amount supplied to the combustion chamber step-by-step when a correcting condition of the injector derived from the driving information detected by the driving information detector is satisfied, while the vehicle is coasting.

### CROSS-REFERENCE TO RELATED APPLICATION

The present application claims priority to Korean Patent Application No. 10-2013-0168494 filed Dec. 31, 2013, the entire contents of which is incorporated herein for all purposes by this reference.

### BACKGROUND OF THE INVENTION

1. Field of the Invention

The present invention relates to an injector-correcting apparatus of a hybrid electric vehicle and method. More particularly, the present invention relates to an injector-correcting apparatus of a hybrid electric vehicle and a method thereof that corrects an injector injecting fuel to a combustion chamber of an engine while coasting and prevents deterioration of output power or generation of vibration or deterioration of exhaust gas due to deterioration of the injector.

2. Description of Related Art

A hybrid vehicle is a vehicle that uses at least two power sources. Generally, the hybrid vehicle is operated by an engine and a motor. The hybrid electric vehicle can be manufactured as various types by using the engine and the motor.

In the hybrid electric vehicle using a diesel engine, an injector that injects fuel to a combustion chamber of the engine is provided.

The fuel injected from the injector is proportional to an injecting time and a square root of pressure of a fuel rail. The fuel pressure of fuel injected into the combustion chamber of the engine through the injector is in range of 150-1600 bar, and a fuel amount injected into the combustion chamber is in range of 0.5-100 mg/st.

However, an error generated when a nozzle provided in the injector is formed and mechanical friction due to continuous use vary in each injector mounted in a vehicle. The fuel amount injected from the injector can be up to 5 mg/st due to these differences.

When the fuel amount injected from the injector is not constant, output power of the engine is deteriorated, vibration in the engine is generated, and exhaust gas exhausted after fuel combustion is deteriorated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an injector correcting apparatus of a hybrid electric vehicle that corrects an injector in order to constantly maintain a fuel amount injected from the injector.

Various aspects of the present invention are directed to providing an injector correcting apparatus of a hybrid electric vehicle that can prevent failure of an engine by correcting an injector.

According to various aspects of the present invention, an injector correcting apparatus of a hybrid electric vehicle may include an engine generating power by combustion of a fuel, a motor supporting power of the engine and selectively operating as a generator, a clutch provided between the engine and the motor, an injector injecting the fuel to a combustion chamber of the engine, a driving information detector detecting driving information of the vehicle including driving distance of the vehicle, vehicle speed, coolant temperature, fuel temperature, and state of charge (SOC) of a battery, and a controller correcting the fuel injection by increasing a fuel amount supplied to the combustion chamber step-by-step when a correcting condition of the injector derived from the driving information detected by the driving information detector is satisfied, while the vehicle is coasting.

The correcting condition of the injector may be satisfied when the vehicle speed is more than a predetermined speed, when the coolant temperature is higher than a predetermined coolant temperature, and when the fuel temperature is higher than a predetermined fuel temperature.

The controller may not correct the fuel injection of the injector when the SOC is less than a predetermined value detected by the driving information detector, and may release engagement of the clutch, may operate the motor as the generator, and may charge the battery by the motor.

The controller may correct the fuel injection of the injector every correcting driving distance.

According to various aspects of the present invention, an injector correcting apparatus of a hybrid electric vehicle may include an engine generating power by combustion of a fuel, an HSG starting the engine and selectively operating as a generator, a motor supporting power of the engine and selectively operating as another generator, a clutch provided between the engine and the motor, an injector injecting the fuel to a combustion chamber of the engine, a driving information detector detecting driving information of the vehicle including driving distance of the vehicle, vehicle speed, coolant temperature, fuel temperature, and SOC of a battery, and a controller correcting the fuel injection by increasing a fuel amount supplied to the combustion chamber step-by-step when a forcible correcting condition of the injector is satisfied and a correcting condition of the injector derived from the driving information detected by the driving information detector is satisfied.

The forcible correcting condition of the injector may be satisfied when the driving distance of the vehicle is more than a predetermined forcible driving distance and the fuel injection is not corrected during the forcible driving distance, or when an engine output according to the fuel injection is more than a predetermined range irrespective of the forcible driving distance.

The correcting condition of the injector is satisfied when the vehicle speed is more than a predetermined speed, when the coolant temperature is higher than a predetermined coolant temperature, and when the fuel temperature is higher than a predetermined fuel temperature.

The controller may operate the engine by the HSG and correct the fuel injection of the injector.

According to various aspects of the present invention, an injector correcting method of a hybrid electric vehicle having an engine generating power by combustion of a fuel, a motor supporting power of the engine and selectively operating as a generator, a clutch provided between the engine and the motor, an injector injecting the fuel to a combustion chamber of the engine, a driving information detector detecting driving information of the vehicle, and a controller correcting the injector according to a driving condition of the vehicle, may include the controller executing a set of instructions for receiving driving information of the vehicle including driving distance of the vehicle, vehicle speed, coolant temperature, fuel temperature, and SOC of the battery, determining whether a forcible correcting condition of the injector is satisfied; determining whether the driving distance of the vehicle is higher than a correcting driving distance for correcting the injector when the forcible correcting condition of the injector is not satisfied, determining whether the vehicle is coasting and the injector correcting condition is satisfied when the driving distance of the vehicle is higher than a correcting driving distance, and correcting the fuel injection of the injector by using a time of explosion of the fuel in the combustion chamber while increasing a fuel amount injected to the combustion chamber of the engine step-by-step when the injector correcting condition is satisfied.

The injector correcting method of a hybrid electric vehicle may further include determining whether the vehicle is coasting and the injector correcting condition is satisfied, when the forcible correcting condition of the injector is satisfied; determining whether the SOC of the battery is more than a predetermined value; and correcting the fuel amount injected from the injector when the vehicle is coasting, the injector correcting condition is satisfied, and the SOC is more than the predetermined value.

The controller may correct the fuel amount injected from the injector by operating the engine through the HSG.

The injector correcting method of a hybrid electric vehicle may further include, correcting the fuel amount injected from the injector by operating the engine through the HSG when the vehicle is not coasting, the injector correcting condition is satisfied, and the SOC is more than the predetermined value.

The forcible correcting condition of the injector may be satisfied when the driving distance of the vehicle is more than a predetermined forcible driving distance and the fuel injection is not corrected during the forcible driving distance, or when the engine output according to the fuel injection is more than a predetermined range irrespective of the forcible driving distance.

The correcting driving distance of the injector may be less than the forcible driving distance.

The injector correcting condition may be satisfied when the coolant temperature is higher than a predetermined coolant temperature and the fuel temperature is higher than a predetermined fuel temperature.

The controller may not correct the fuel injection of the injector when the SOC is less than a predetermined value detected by the driving information detector, and releases engagement of the clutch, operates the motor as a generator, and charges the battery by the motor.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic view illustrating an exemplary injector correcting apparatus of a hybrid electric vehicle according to the present invention.

FIG. 2 is a flowchart illustrating an exemplary injector correcting method of the hybrid electric vehicle according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

A hybrid electric vehicle according various embodiments of the present invention will be exemplarily described as a Transmission Mounted Electric Device (TMED). However, the present invention is not limited thereto, and may be applied to another type of hybrid electric vehicle.

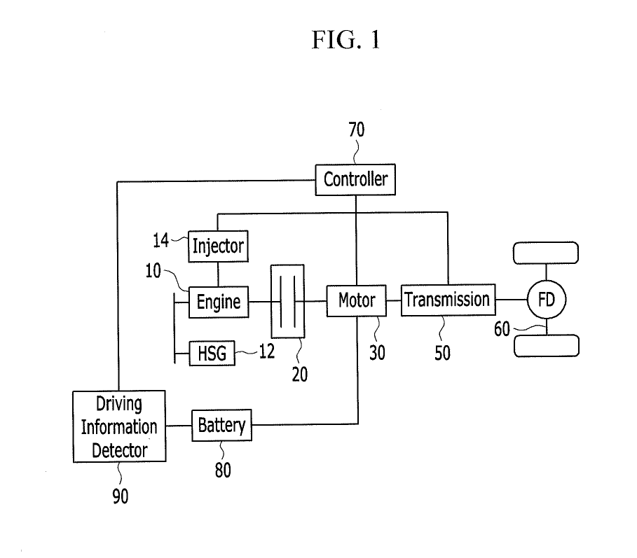

FIG. 1 is a schematic view illustrating an injector correcting apparatus of a hybrid electric vehicle according to various embodiments of the present invention.

As shown in FIG. 1, an injector correcting apparatus of a hybrid electric vehicle according to various embodiments of the present invention includes an engine 10 generating power by combustion of fuel, a motor 30 supporting power of the engine and selectively operating as a generator, a clutch 20 provided between the engine 10 and the motor 30, an injector 14 injecting fuel to a combustion chamber of the engine 10, a driving information detector 90 detecting driving information of a vehicle, and a controller 70 controlling the engine 10, the motor 30, the clutch 20, and the injector 14.

The motor 30 supports power of the engine 10, operates as a generator as necessary, generates power, and charges the power to a battery through an inverter.

The clutch 20 provided between the engine 10 and the motor 30 of the hybrid electric vehicle is driven in an EV (electric vehicle) mode or an HEV (hybrid electric vehicle) mode according to engagement of the clutch 20.

The driving information detector 90 detects driving information of the vehicle including driving distance of the vehicle, vehicle speed, coolant temperature, fuel temperature, and SOC of the battery, and provides the driving information to the controller 70.

The controller 70 can be realized by one or more processors activated by a predetermined program, and the predetermined program can be programmed to perform each step of an injector correcting method of a hybrid electric vehicle according to various embodiments of the present invention.

A Hybrid Starter Generator (HSG) 12 is further provided for starting the engine. The HSG is operated as a starter and generator. The HSG starts the engine by a control signal of the controller 70, is operated as a generator while operation of the engine is maintained, and generates power. The power generated by the HSG is charged to a battery 80.

The controller 70 performing correction of the injector according to various embodiments of the present invention will now be described.

The controller 70 corrects a fuel amount of injection injected from the injector 14 when a correcting condition of the injector 14 is satisfied during coasting.

During coasting, the clutch 20 is engaged and power generated by inertia is transferred to the engine 10, thus the engine 10 rotates passively.

The correcting condition of the injector is satisfied when the vehicle speed is more than a predetermined speed, when the coolant temperature is higher than a predetermined temperature, and when the fuel temperature is higher than a predetermined temperature.

It requires about one second in order to correct the injector 14, and therefore the vehicle speed should be more than the predetermined speed. Also, during the coasting, the injector 14 can be corrected when the coolant temperature and the fuel temperature are more than predetermined temperatures.

The controller 70 does not correct the injector 14 when a SOC (state of charge) of the battery is very low. When the SOC is less than a predetermined value, the controller 70 releases engagement of the clutch 20, operates the motor 30 as a generator, and charges the battery. This is because charging of the battery is more important than correction of the injector 14 when the SOC is very low.

In order to correct the injector 14, the controller 70 rotates the engine passively and injects fuel to the combustion chamber of the engine 10 by increasing a small fuel amount step-by-step. When the fuel amount is small, an explosion does not occur in the combustion chamber. However, when the fuel amount injected into the combustion chamber is increased step-by-step, at one point, an explosion does occur in the combustion chamber. At this time, the controller 70 evaluates the fuel amount at the time of the explosion in the combustion chamber and corrects the fuel injection of the injector 14 based on this.

The controller 70 corrects fuel injection of the injector each predetermined driving distance (for example, 2000 km) (hereinafter referred to as a “correcting driving distance”). However, fuel injection may not be corrected even though the driving distance of the vehicle is over the correcting driving distance.

In this case, the controller 70 forcibly corrects fuel injection of the injector 14. That is, the controller 70 forcibly corrects fuel injection of the injector 14 when the injector 14 is not corrected during a forcible driving distance (for example, 5000 km).

When the controller 70 forcibly corrects fuel injection of the injector 14, the controller engages the clutch and operates the engine passively through the HSG. The controller 70 then corrects fuel injection of the injector 14 by increasing a small fuel amount step-by-step.

An injector correcting method of a hybrid electric vehicle according to various embodiments of the present invention will now be described in detail.

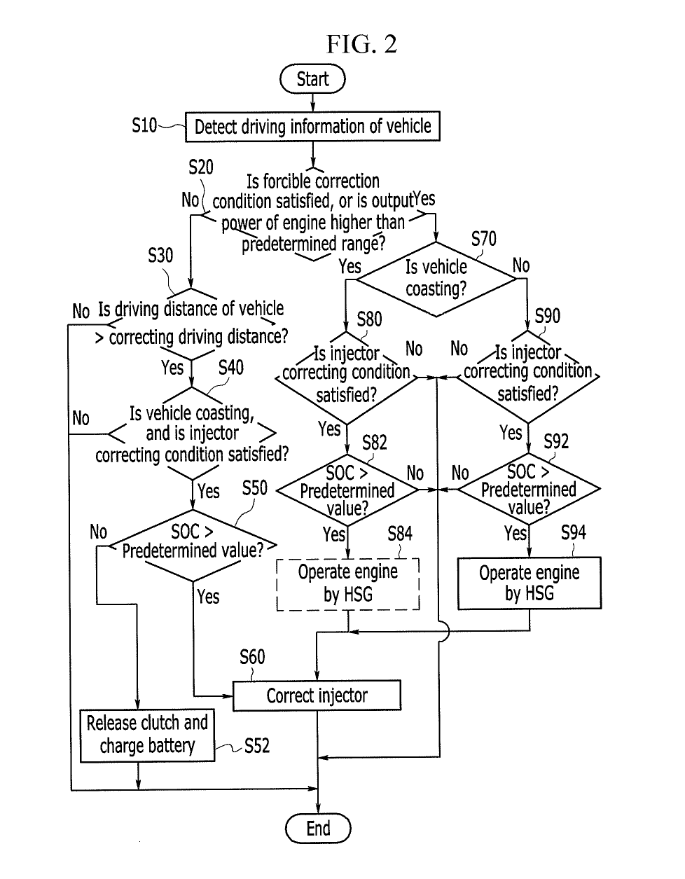

FIG. 2 is a flowchart illustrating an injector correcting method of hybrid electric vehicle according to various embodiments of the present invention.

As shown in FIG. 2, the driving information detector 90 detects driving information of the vehicle including driving distance of the vehicle, vehicle speed, coolant temperature, fuel temperature, and SOC of the battery at step S10.

The controller 70 receives the driving information detected by the driving information detector 90.

The controller 70 determines whether a forcible correcting condition of the injector is satisfied or whether output power of the engine according to fuel injection is more than predetermined range at step S20.

Here, the forcible correcting condition is satisfied when the driving distance of the vehicle is more than a predetermined forcible driving distance (for example, 5000 km) and the fuel injection is not corrected during the forcible driving distance.

When output power of the engine according to fuel injection is more than the predetermined range, the controller 70 determines that failure of the injector has occurred and forcibly corrects the injector.

When the forcible correcting condition is not satisfied, the controller 70 determines whether the driving distance of the vehicle is more than a correcting driving distance (for example, 2000 km) for correcting the injector 14 at step S30.

When the driving distance of the vehicle is more than the correcting driving distance, the controller 70 determines whether the vehicle is coasting and whether an injector correcting condition is satisfied at step S40. During the coasting, the clutch 20 is engaged and power generated by inertia is transferred to the engine 10, and thus the engine 10 passively rotates.

Here, the injector correcting condition is satisfied when the vehicle speed is more than a predetermined speed, when the coolant temperature is higher than a predetermined temperature, and when the fuel temperature is higher than a predetermined temperature.

Meanwhile, the controller 70 determines whether the SOC of the battery is more than a predetermined value. When the SOC is less than the predetermined value, the controller 70 releases engagement of the clutch 20, operates the motor 30 as a generator, and charges the battery at step S52. This is because charging the battery is more important than correcting the injector 14 when the SOC is very low.

When the SOC is more than the predetermined value, the controller 70 corrects the fuel injection of the injector 14 at step S60.

A method for correcting the injector 14 is as follows. First, the controller 70 injects fuel to the combustion chamber of the engine 10 by increasing a small fuel amount step-by-step. When the fuel amount is small, an explosion does not occur in the combustion chamber. However, when the fuel amount injected to the combustion chamber is increased step-by-step, at one point, an explosion does occur in the combustion chamber. At this time, the controller 70 evaluates the fuel amount at the time of the explosion in the combustion chamber and corrects the fuel injection of the injector 14 based on this.

The controller determines whether the vehicle is coasting when the forcible correcting condition is satisfied or when output power of the engine according to fuel injection is more than a predetermined range at step S70.

The controller 70 determines whether the injector correcting condition is satisfied when the vehicle is coasting at step S80.

The controller 70 determines whether the SOC of the battery is more than the predetermined value when the vehicle coasts and when the injector correcting condition is satisfied at step S82.

The controller 70 corrects fuel injection of the injector 14 when the SOC is more than the predetermined value at step S60. The controller 70 does not correct fuel injection of the injector 14 when the SOC is less than the predetermined value. A method of correcting fuel injection of the injector 14 is the same as described above, so a detailed description thereof is omitted.

Meanwhile, the controller 70 can correct fuel injection of the injector 14 by driving the engine through the HSG 12 while the vehicle coasts at step S84.

In the step S70, if the controller 70 determines that the vehicle is not coasting, the controller 70 determines whether the injector correcting condition is satisfied at step S90.

When the vehicle is not coasting and the injector correcting condition is not satisfied, the controller 70 determines whether the SOC of the battery is more than the predetermined value at step S92.

When the SOC is more than the predetermined value, the controller 70 operates the engine 10 through the HSG 12 and corrects fuel injection of the injector 14 at step S94. As such, the controller 70 can correct fuel injection of the injector 14 by driving the engine forcibly through the HSG 12 when the vehicle does not coast.

According to various embodiments of the present invention, a fuel amount injected from an injector can be corrected during coasting.

Further, unnecessary correction of an injector can be prevented and fuel injected from the injector can be controlled precisely by correction of the injector, thus fuel efficiency is increased.

Further, since correction of an injector is performed according to predetermined conditions, failure of an engine is prevented.

Further, an engine is operated by an HSG and an injector can be corrected while not coasting.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An injector correcting apparatus of a hybrid electric vehicle, comprising:
an engine generating power by combustion of a fuel;
a motor supporting power of the engine and selectively operating as a generator;
a clutch provided between the engine and the motor;
an injector injecting the fuel to a combustion chamber of the engine;
a driving information detector detecting driving information of the vehicle including driving distance of the vehicle, vehicle speed, coolant temperature, fuel temperature, and state of charge (SOC) of a battery; and
a controller correcting the fuel injection by increasing a fuel amount supplied to the combustion chamber step-by-step when a correcting condition of the injector derived from the driving information detected by the driving information detector is satisfied, while the vehicle is coasting.

2. The injector correcting apparatus of the hybrid electric vehicle of claim 1,
wherein the correcting condition of the injector is satisfied when the vehicle speed is more than a predetermined speed, when the coolant temperature is higher than a predetermined coolant temperature, and when the fuel temperature is higher than a predetermined fuel temperature.

3. The injector correcting apparatus of the hybrid electric vehicle of claim 1,
wherein the controller does not correct the fuel injection of the injector when the SOC is less than a predetermined value detected by the driving information detector, and releases engagement of the clutch, operates the motor as the generator, and charges the battery by the motor.

4. The injector correcting apparatus of the hybrid electric vehicle of claim 1,
wherein the controller corrects the fuel injection of the injector every correcting driving distance.

5. An injector correcting apparatus of a hybrid electric vehicle comprising:
an engine generating power by combustion of a fuel;
an HSG starting the engine and selectively operating as a generator;
a motor supporting power of the engine and selectively operating as another generator;
a clutch provided between the engine and the motor;
an injector injecting the fuel to a combustion chamber of the engine;
a driving information detector detecting driving information of the vehicle including driving distance of the vehicle, vehicle speed, coolant temperature, fuel temperature, and SOC of a battery; and
a controller correcting the fuel injection by increasing a fuel amount supplied to the combustion chamber step-by-step when a forcible correcting condition of the injector is satisfied and a correcting condition of the injector derived from the driving information detected by the driving information detector is satisfied.

6. The injector correcting apparatus of the hybrid electric vehicle of claim 5,
wherein the forcible correcting condition of the injector is satisfied when the driving distance of the vehicle is more than a predetermined forcible driving distance and the fuel injection is not corrected during the forcible driving distance, or when an engine output according to the fuel injection is more than a predetermined range irrespective of the forcible driving distance.

7. The injector correcting apparatus of the hybrid electric vehicle of claim 5,
wherein the correcting condition of the injector is satisfied when the vehicle speed is more than a predetermined speed, when the coolant temperature is higher than a predetermined coolant temperature, and when the fuel temperature is higher than a predetermined fuel temperature.

8. The injector correcting apparatus of the hybrid electric vehicle of claim 5, wherein the controller operates the engine by the HSG and corrects the fuel injection of the injector.

9. An injector correcting method of a hybrid electric vehicle having an engine generating power by combustion of a fuel, a motor supporting power of the engine and selectively operating as a generator, a clutch provided between the engine and the motor, an injector injecting the fuel to a combustion chamber of the engine, a driving information detector detecting driving information of the vehicle, and a controller correcting the injector according to a driving condition of the vehicle, including the controller executing a set of instructions for:
receiving driving information of the vehicle including driving distance of the vehicle, vehicle speed, coolant temperature, fuel temperature, and SOC of a battery;
determining whether a forcible correcting condition of the injector is satisfied;
determining whether the driving distance of the vehicle is higher than a correcting driving distance for correcting the injector when the forcible correcting condition of the injector is not satisfied;
determining whether the vehicle is coasting and the injector correcting condition is satisfied when the driving distance of the vehicle is higher than a correcting driving distance; and
correcting the fuel injection of the injector by using a time of explosion of the fuel in the combustion chamber while increasing a fuel amount injected to the combustion chamber of the engine step-by-step when the injector correcting condition is satisfied.

10. The injector correcting method of the hybrid electric vehicle of claim 9, further comprising:
determining whether the vehicle is coasting and the injector correcting condition is satisfied, when the forcible correcting condition of the injector is satisfied;
determining whether the SOC of the battery is more than a predetermined value; and
correcting the fuel amount injected from the injector when the vehicle is coasting, the injector correcting condition is satisfied, and the SOC is more than the predetermined value.

11. The injector correcting method of the hybrid electric vehicle of claim 9,
wherein the controller corrects the fuel amount injected from the injector by operating the engine through the HSG.

12. The injector correcting method of the hybrid electric vehicle of claim 10, further comprising:
correcting the fuel amount injected from the injector by operating the engine through the HSG when the vehicle is not coasting, the injector correcting condition is satisfied, and the SOC is more than the predetermined value,

13. The injector correcting method of the hybrid electric vehicle of claim 9,
wherein the forcible correcting condition of the injector is satisfied when the driving distance of the vehicle is more than a predetermined forcible driving distance and the fuel injection is not corrected during the forcible driving distance, or when the engine output according to the fuel injection is more than a predetermined range irrespective of the forcible driving distance.

14. The injector correcting method of the hybrid electric vehicle of claim 13,
wherein the correcting driving distance of the injector is less than the forcible driving distance.

15. The injector correcting method of the hybrid electric vehicle of claim 9,
wherein the injector correcting condition is satisfied when the coolant temperature is higher than a predetermined coolant temperature and the fuel temperature is higher than a predetermined fuel temperature.

16. The injector correcting method of hybrid electric vehicle of claim 9,
wherein the controller does not correct the fuel injection of the injector when the SOC is less than a predetermined value detected by the driving information detector, and releases engagement of the clutch, operates the motor as a generator, and charges the battery by the motor.

17. The injector correcting method of the hybrid electric vehicle of claim 10,
wherein the injector correcting condition is satisfied when the coolant temperature is higher than a predetermined coolant temperature and the fuel temperature is higher than a predetermined fuel temperature.
